(19) United States
(12) Patent Application Publication
(10) Pub. No.: US 2004/0250178 A1
(43) Pub. Date: Dec. 9, 2004

(54) Secure watchdog timer

(76) Inventors: Peter R. Munguia, Chandler, AZ (US); Kyle D. Gilsdorf, Phoenix, AZ (US); Shailendra Jha, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/444,562

(22) Filed: May 23, 2003

(51) Int. Cl. H02H 3/05

(52) U.S. Cl. 714/55

(57) ABSTRACT

A watchdog timer including a counter, a watchdog enable mechanism, and a timeout control. The watchdog enable mechanism is set to an enabled state by receiving an enabling input and set to a disabled state only by a power cycle or a hardware reset. The timeout control is coupled to the counter and to the watchdog enable mechanism. The timeout control enables a error signal if the watchdog enable mechanism is enabled and the counter is not updated before completing a count.

### BACKGROUND OF THE INVENTION

A watchdog timer is an electronic timing circuit that generates a signal when a computer processor is not executing a software program in the intended manner. The signal may be used to cause the computer processor to recover from the unintended mode of operation or otherwise respond to the error condition.

The software program is written so that it will periodically update the watchdog timer. If the software program fails to update the watchdog timer within an appropriate length of time it can be inferred that the software program is not executing in the intended manner. When the watchdog timer measures the appropriate length of time elapsing without receiving an update from the software program, the watchdog timer generates a signal that indicates the error condition.

### BRIEF DESCRIPTION OF THE DRAWINGS

FIG. 1 is a block diagram of an embodiment of the invention.

FIG. 2 is a block diagram of an embodiment of the watchdog timer mechanism shown in FIG. 1.

FIG. 3 is a block diagram of another embodiment of the invention.

FIG. 4 is a block diagram of a computer system that includes an embodiment of the invention.

### DETAILED DESCRIPTION OF THE INVENTION

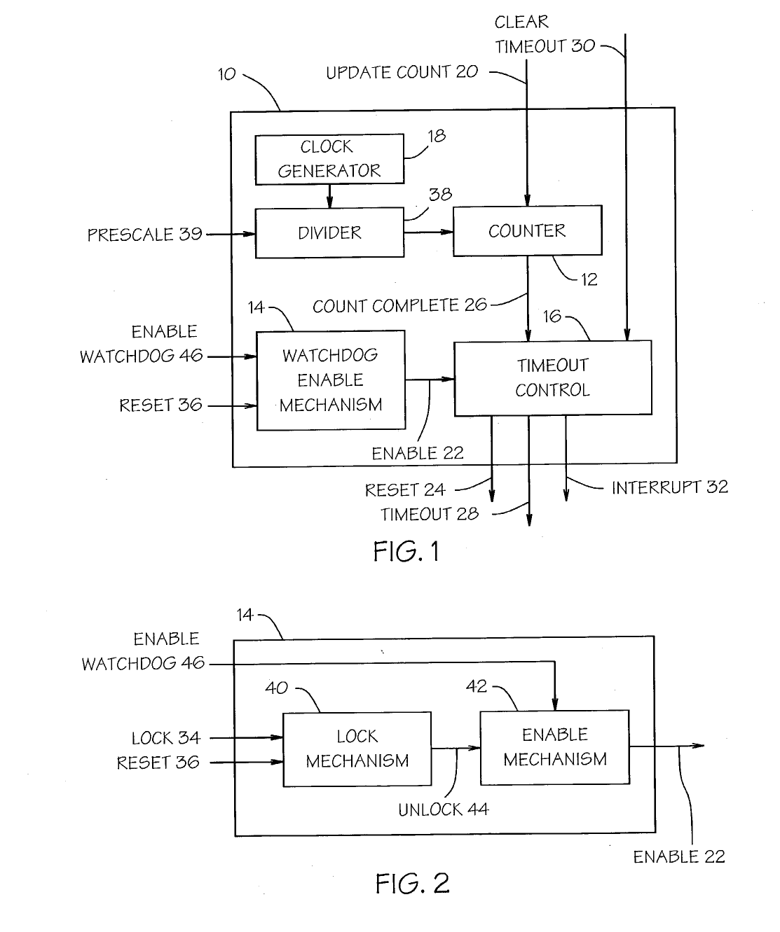

As shown in FIG. 1, a watchdog timer 10 that includes an embodiment of the invention may include a counter 12, a watchdog enable mechanism 14, and a timeout control 16. The counter may count a series of pulses, which may be a clock signal provided by an internal clock generator 18, to measure elapsed time. In another embodiment, the clock signal may be provided by an external source. The watchdog timer may include a prescale divider 38 to provide a series of pulses having a frequency that is the frequency of the clock signal divided by a prescale value 39. The counter may be configured to measure an appropriate length of time to infer that a computer processor is not executing a software program in the intended manner. The appropriate length of time may be measured by completing a predetermined count of pulses. The counter may be updated by an update count input 20 from a software program to restart the measurement of elapsed time and prevent the counter from completing a count.

The watchdog enable mechanism 14 may disable and enable operation of the watchdog timer by providing an enable signal 22 to the timeout control 16. In some embodiments, the watchdog timer may be an operating mode of a general purpose timing circuit that is enabled by the watchdog enable mechanism 14. A general purpose timing circuit may provide other timing functions if the watchdog enable mechanism 14 is disabled. In one embodiment, operation of the watchdog timer 10 may be suspended when the computer processor clock is stopped.

The timeout control 16 enables an error signal 24 that may initiate error recovery for a computer processor. The error signal 24 may cause a hardware reset of the computer processor. The timeout control 16 may be coupled to the counter 1 2 and to the watchdog enable mechanism 14. The error signal 24 is enabled if the watchdog enable mechanism 14 is enabled 22 and the counter 12 is not updated by an update count input 20 before completing a count and providing the count complete signal 26 to the timeout control 16. In one embodiment, the error signal 24 is a persistent error signal that is disabled only by a power cycle or a hardware reset. It is not possible for a software program to disable the persistent error signal 24 once it has been enabled by the timeout control 16.

In another embodiment, the watchdog timer 10 provides a timeout flag 28 that is set when the error signal 24 is enabled. The timeout flag 28 may persist through a power cycle or a hardware reset. The persistent timeout flag 28 may be reset by a clear timeout input 30 provided by a software program. The persistent timeout flag 28 may allow the software program to determine that the system was restarted in response to a watchdog timeout.

In another embodiment, the timeout control may provide for multiple stages of timeout control. In one embodiment, a two stage recovery procedure may be provided. The first completion of a count by the counter 12 may enable an Interrupt Request (IRQ) 32 or a System Management Interrupt (SMI) to initiate a software procedure for error recovery. Completion of a second count by the counter 12 may enable the error signal 24 to provide for error recovery when the software error recovery is unsuccessful.

In other embodiments, more than two signals may be provided to provide for more than two stages of recovery. This permits systems to employ progressively more aggressive actions for error recovery when unintended operation of the processor continues for various additional periods of time after earlier recovery attempts. In one embodiment, five signals are provided. For example, these five signals might be used to cause a system to progressively invoke recovery signals as follows:

1) an interrupt if an update is not received within five seconds of the previous update;

2) a system management interrupt if an additional five minutes elapse without an update;

3) a local area network (LAN) alert message if an additional minute elapses without an update;

4) a hardware reset if an additional ten minutes elapse without an update;

5) a power down if an additional sixty minutes elapse without an update;

In another embodiment, one or more of the signals 24, 28, 32 generated by completion of a count may be an oscillating output. A configuration control register may allow the signal to be configured as one of a fixed error signal and an oscillating output under software control. The oscillating output may be produced by operating the counter 12 in a free-running mode after the counter completes a count that indicates a watchdog timeout. The counter may be reconfigured by the watchdog timer to provide a frequency of the oscillating output that is independent of the watchdog timeout interval.

An oscillating output may be used to enable an audible or visual alarm. A sound transducer, such as a speaker, may be driven directly by the oscillating output to produce a tone at the frequency of the oscillating output. A visual indicator, such as a light emitting diode (LED), may be driven directly by the oscillating output to produce a flashing light at the frequency of the oscillating output. Producing an audible or visual signal when unexpected operation of a processor is detected by the watchdog timer may be useful for systems that use embedded processors, which may be stand-alone specialized devices rather than general purpose computers. The frequency of the oscillating output may be controlled by a register that provides a counter value that used is used to divide an input clock signal and produce a corresponding oscillation frequency.

The watchdog enable mechanism 14 may be set to an enabled state by receiving an enable watchdog input 46. Once enabled, the watchdog enable mechanism 14 may be set to a disabled state only by a power cycle or a hardware reset 36. It may not be possible for a software program to reset the watchdog enable mechanism 14 to the disabled state after it has been enabled. This may prevent a software program that is operating in an unintended and unpredictable manner from unintentionally disabling the watchdog timer.

As shown in FIG. 2, the watchdog enable mechanism 14 may include a lock mechanism 40 and an enable mechanism 42. The lock mechanism 40 may be a write-once bit that is enabled by receiving a lock input 34 and disabled only by the power cycle or the hardware reset 36. The enable mechanism 42 may provide the enable signal 22 for the watchdog enable mechanism 14. The enable mechanism 42 may be coupled to the lock mechanism 40 such that, if the unlock signal 44 is asserted, the enable mechanism 42 is set by receiving a first input on an enable watchdog input 46 and reset by receiving a second input on the enable watchdog input 46. When the unlock signal 44 is not asserted, the enable mechanism 42 is unchanged by any of the first input and the second input on the enable watchdog input 46.

The lock mechanism 40 may be used by the program that initializes a system, such as the basic input/output system (BIOS), to enable or disable the watchdog timer and prevent the operating system from altering the status as set during initialization. The initializing program may also enable or disable the watchdog timer without using the lock mechanism 40, in which case the operating system may later alter the status as set during initialization and may further lock that setting if desired.

In an embodiment where the watchdog enable mechanism 14 includes a lock mechanism 40 coupled to an enable mechanism 42, it is not possible for a software program to later enable or disable the watchdog enable mechanism 14 after the lock mechanism 40 is enabled. This may prevent a software program that is operating in an unintended and unpredictable manner from changing the state of the enable mechanism 42 and causing the watchdog timer to operate in an unintended mode. If the lock mechanism 40 is a write-once bit, the state of the enable mechanism 42 may be particularly well protected against unintentional changes because the software will be unable to unlock the enable mechanism so that its state can be changed.

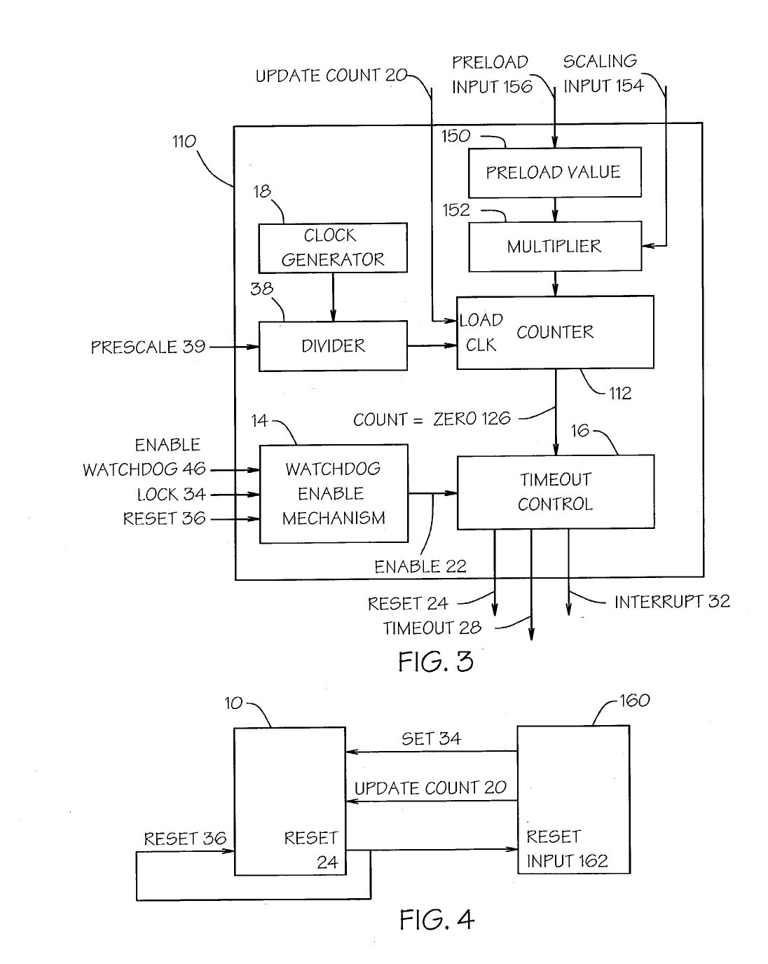

As shown in FIG. 3, another embodiment of the watchdog timer 110 may include a preload register 150 coupled to the counter 112. The preload register 150 may hold a preload value. The preload value may be supplied by a software program as a preload input 156. The update count input 120 may be coupled to the counter 112 to cause the counter to load the preload value as the current count. The counter 112 may count down from the preload value toward zero to complete the count and enable the count=zero 126 signal as the count complete signal. In another embodiment, the watchdog timer may include a multiplier 152 to provide a settable scaling value that multiplies the preload value as determined by a scaling input 154 to increase the number of pulses required to complete the count. Multiplying the preload value may be by left shifting the preload value.

In one embodiment, the counter may be updated by receiving a register unlocking sequence immediately followed by receiving an update input. If the unlocking sequence and update is interrupted by receiving an input that is not part of the exact inputs required to update the counter, the counter will not be updated. The unlocking sequence and update must be received by the watchdog timer without interruption in this embodiment. An exemplary unlocking sequence might be writing a first specific value, such as “80”, to a specific location known to the watchdog timer, and then writing a second specific value, such as “86”, to the specific location. An exemplary update input might be setting a specific bit in a control register of the watchdog timer. In another embodiment, the unlocking sequence may be required preceding writing the input for resetting the timeout flag. In yet another embodiment, the unlocking sequence may be required preceding writing the preload value to the watchdog timer.

FIG. 4 shows a computer system that includes an embodiment of the invention. A processor 160 has a reset input 162 to receive a hardware reset that puts the processor into a known state and restarts the processor when the hardware reset is enabled. A watchdog timer 10 is coupled to the reset input 162. The watchdog timer 10 may include the elements discussed above. As previously described the watchdog timer may include a timeout control coupled to a counter and to a watchdog enable mechanism. The timeout control may enable a error signal output 24 on the watchdog timer 10 if the watchdog enable mechanism is enabled and the counter is not updated before completing a count. The error signal output 24 may be coupled to the reset input 162 of the processor 160.

The watchdog timer 10 may include a watchdog enable mechanism that is set to an enabled state by receiving an enabling input 34 and set to a disabled state only by one of a power cycle and the hardware reset 36. While the reset input 162 and the hardware reset 36 are shown as being coupled directly to the error signal output 24 of the watchdog timer 10, it will be appreciated that the error signal output may provide an enabling input to additional circuitry that generates the signals provided to the reset input 162 and the hardware reset 36.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A watchdog timer, comprising:
a counter;
a watchdog enable mechanism that is set to an enabled state by receiving an enabling input and set to a disabled state only by one of a power cycle and a hardware reset; and
a timeout control coupled to the counter and to the watchdog enable mechanism, the timeout control to enable an error signal if the watchdog enable mechanism is enabled and the counter is not updated before completing a count.

2. The watchdog timer of claim 1, wherein the watchdog enable mechanism further comprises:
a lock mechanism that is enabled by receiving the enabling input and disabled only by one of the power cycle and the hardware reset; and,
an enable mechanism coupled to the lock mechanism, the enable mechanism providing the state of the watchdog enable mechanism, if the lock mechanism is disabled the enable mechanism is set by receiving a first input and reset by receiving a second input, otherwise the enable mechanism is unchanged by any of the first input and the second input.

3. The watchdog timer of claim 1, further comprising a preload register coupled to the counter, the preload register to hold a preload value, wherein updating the counter causes the counter to load the preload value and to count down toward zero to complete the count.

4. The watchdog timer of claim 3, further comprising a multiplier coupled to the preload register and to the counter, the multiplier to multiply the preload value when loaded by the counter responsive to a scaling input.

5. The watchdog timer of claim 1, wherein the counter is updated by receiving a register unlocking sequence immediately followed by receiving an update input.

6. The watchdog timer of claim 1, wherein the error signal is disabled only by one of the power cycle and the hardware reset.

7. The watchdog timer of claim 1, wherein the error signal is an oscillating output.

8. The watchdog timer of claim 1, wherein the timeout control is further to enable a second error signal if the error signal is enabled and the counter is not updated before completing a second count.

9. A method of providing a watchdog timer function, comprising:
counting a series of pulses toward a completion value;
receiving only one of a power cycle and a hardware reset to set a watchdog enable mechanism to a disabled state;
receiving an enabling input to set the watchdog enable mechanism to an enabled state;
enabling an error signal if the watchdog enable mechanism is set to the enabled state and the counting reaches the completion value.

10. The method of claim 9, wherein providing the watchdog enable mechanism further comprises:
receiving only one of the power cycle and the hardware reset to disable a lock mechanism;
receiving the enabling input to enable the lock mechanism;
receiving a first input to set an enable mechanism if the lock mechanism is disabled;
receiving a second input to reset the enable mechanism if the lock mechanism is disabled;
ignoring the first input and the second input if the lock mechanism is enabled;
providing the state of the enable mechanism as the state of the watchdog enable mechanism.

11. The method of claim 9, further comprising:
holding a preload value in a preload register;
updating to cause counting from the preload value toward the completion value.

12. The method of claim 11, further comprising multiplying the preload value responsive to a scaling input when updating.

13. The method of claim 9, further comprising updating to cause counting toward the completion value to require counting additional pulses.

14. The method of claim 13, further comprising:
receiving a register unlocking sequence;
receiving an update input immediately following the register unlocking sequence to cause the updating.

15. The method of claim 9, further comprising disabling the error signal only if one of the power cycle and the hardware reset is received.

16. The method of claim 9, wherein enabling an error signal further comprises enabling an oscillator to provide the error signal.

17. The method of claim 9, further comprising enabling a second error signal if the error signal is set to the enabled state and the counting reaches a second completion value.

18. A watchdog timer, comprising:
a counter means for completing a count;
a timeout control means for enabling an error signal if the counter means is not updated before completing the count; and
a watchdog enable means for enabling the timeout control means by receiving an enabling input and setting the timeout control means to a disabled state only by one of a power cycle and a hardware reset.

19. The watchdog timer of claim 18, wherein the watchdog enable means further comprises:
a lock means for receiving the enabling input, the power cycle, and the hardware reset; and,
an enable means coupled to the lock means, the enable means for providing the state of the watchdog enable means.

20. The watchdog timer of claim 18, further comprising a preload register means coupled to the counter means, the preload register means for holding a preload value, wherein updating the counter means causes the counter means to load the preload value and count down toward zero to complete the count.

21. The watchdog timer of claim 20, further comprising a multiplier means coupled to the preload register means and to the counter means, the multiplier means for multiplying the preload value responsive to a scaling input when updating the counter means.

22. The watchdog timer of claim 18, wherein the counter means is updated by receiving a register unlocking sequence immediately followed by receiving an update input.

23. The watchdog timer of claim 18, wherein the error signal is disabled only by one of the power cycle and the hardware reset.

24. The watchdog timer of claim 18, wherein the error signal is an oscillating output.

25. The watchdog timer of claim 18, wherein the timeout control means is further for enabling a second error signal if the error signal is enabled and the counter means is not updated before completing a second count.

26. A computer system, comprising:
a processor having a reset input to receive a hardware reset that puts the processor into a known state and restarts the processor when the hardware reset is enabled;
a watchdog timer coupled to the reset input, the watchdog timer including
a counter,
a watchdog enable mechanism that is set to an enabled state by receiving an enabling input and set to a disabled state only by one of a power cycle and the hardware reset, and
a timeout control coupled to the counter and to the watchdog enable mechanism, the timeout control to enable the hardware reset if the watchdog enable mechanism is enabled and the counter is not updated before completing a count.

27. The computer system of claim 26, wherein the watchdog enable mechanism further comprises:
a lock mechanism that is enabled by receiving the enabling input and disabled only by one of the power cycle and the hardware reset; and,
an enable mechanism coupled to the lock mechanism, the enable mechanism providing the state of the watchdog enable mechanism, if the lock mechanism is disabled the enable mechanism is set by receiving a first input and reset by receiving a second input, otherwise the enable mechanism is unchanged by any of the first input and the second input.

28. The computer system of claim 26, further comprising a preload register coupled to the counter, the preload register to hold a preload value, wherein updating the counter causes the counter to load the preload value and to count down toward zero to complete the count.

29. The computer system of claim 28, further comprising a multiplier coupled to the preload register and to the counter, the multiplier to multiply the preload value when loaded by the counter responsive to a scaling input.

30. The computer system of claim 26, wherein the counter is updated by receiving a register unlocking sequence immediately followed by receiving an update input.
